(19) United States
(12) Patent Application Publication
(10) Pub. No.: US 2014/0274059 A1
(43) Pub. Date: Sep. 18, 2014

(54) PLMN SELECTION AT HANDOVER TO A TARGET SHARED LOCATION BEING SHARED BETWEEN CORE NETWORK OPERATORS

(71) Applicant: TELEFONAKTIEBOLAGET L M ERICSSON (PUBL), Stockholm (SE)

(72) Inventors: Peter Ramle, Molnlycke (SE); Mathias Johansson, Vastra Frolunda (SE); Lars-Bertil Olsson, Angered (SE)

(73) Assignee: TELEFONAKTIEBOLAGET L M ERICSSON (PUBL), Stockholm (SE)

(21) Appl. No.: 14/355,659

(22) PCT Filed: Oct. 25, 2012
(86) PCT No.: PCT/EP2012/071148

§ 371 Date: May 1, 2014

Related U.S. Application Data
(60) Provisional application No. 61/554,510, filed on Nov. 2, 2011.

(51) Int. Cl. H04W 36/08

(52) U.S. Cl. CPC H04W 36/08
USPC 455/436

(57) ABSTRACT

This disclosure relates to Network Sharing and in particular to a source core network node 410s for handling handover of a user equipment 401 from a source location 400s to a target shared location 400t and a method performed in that source core network node 410s for handling handover of a user equipment 401 from a source location 400s to a target shared location 400t, which target shared location 400t is shared between core network operators. The method comprises receiving 501, 601, from a source radio access network node 405s, a request for handover of the user equipment 401 from the source location 400s to the target shared location 400t, which request comprises information indicating a first target Public Land Mobile Network, PLMN served at the target shared location 400t and intended to serve the user equipment 401 at the target shared location 400t; obtaining 502, 602 information indicating a candidate target PLMN associated with the user equipment 401, which candidate target PLMN is served at the target shared location 400t; and determining 503, 603, based on the received information indicating the first target PLMN and the obtained information indicating the candidate target PLMN, that the first target PLMN shall be replaced by a second target PLMN to serve the user equipment 401 in the target shared location 400t, which second target PLMN is served at the target shared location 400t.

### TECHNICAL FIELD

Embodiments herein relate generally to a source core network node and a method in the source core network node. More particularly, the embodiments herein relate to a Public Land Mobile Network (PLMN) selection at HandOver (HO) to a target shared location.

### BACKGROUND

In a typical communications network, also referred to as e.g. a wireless communications system, a wireless communications network, a communications network or a communications system, a User Equipment (UE), communicates via a Radio Access Network (RAN) to one or more Core Networks (CN).

A user equipment is a mobile terminal by which a subscriber may access services offered by an operator's network and services outside the operator's network to which the operator's radio access network and core network provide access, e.g. access to the Internet. The user equipment may be for example a communication device such as a mobile telephone, cellular telephone, smart phone, tablet computer, Machine to Machine device (M2M) or laptop with wireless capability. The user equipment may be portable, pocket-storable, hand-held, computer-comprised, or vehicle-mounted mobile devices, enabled to communicate voice and/or data, via the radio access network, with another entity, such as another mobile station or a server.

The user equipment is enabled to communicate wirelessly in the communications network. The communication may be performed e.g. between two user equipments, between the user equipment and a server via the radio access network and possibly one or more core network comprised within the communications network.

The communications network covers a geographical area which may be divided into cell areas, and therefore the communications network may be referred to as a cellular network. Each cell area is served by a Base Station (BS), e.g. a Radio Base Station (RBS), which sometimes may be referred to as e.g. evolved Node B (eNB), eNodeB, NodeB, B node, or Base Transceiver Station (BTS), depending on the technology and terminology used. The base station communicates over the air interface operating on radio frequencies with the user equipment within range of the base station.

FIG. 1 is a block diagram illustrating embodiments of the architecture of a communications network 100 based on Evolved Packet System (EPS). The communications network 100 comprises Evolved—UMTS Terrestrial Radio Access Network (E-UTRAN) 103 on the radio access network side and Evolved Packet Core (EPC) on the core side. EPS may also be referred to as Long Term Evolution (LTE). UMTS is short for Universal Mobile Telecommunications System. In more detail, FIG. 1 illustrates embodiments of a non-roaming architecture for an EPS. Roaming refers to the ability for the user equipment 101 to automatically make and receive voice calls, send and receive data, or access other services, comprising home data services, when travelling outside the geographical coverage area of the user equipment's home network, using a visited network. In other words, when a user equipment moves around a network in idle mode, it is referred to as roaming. Non-roaming refers to the opposite of roaming.

The EPS comprises a radio access network referred to as E-UTRAN and a core network referred to as EPC. The user equipment 101 may interact with the EPS using the E-UTRAN 103 radio access. The interface between the user equipment 101 and E-UTRAN 103 is called LTE-Uu. User equipment related control signaling is handled by a Mobility Management Entity (MME) 105 with support of subscription information provided by a Home Subscriber Server (HSS) 108. The interface between the E-UTRAN 103 and the MME 105 is called S1-MME and the interface between the MME 105 and the HSS 108 is called S6a. S10 is the interface between several MMEs. User equipment payload is handled by the Serving GateWay (SGW) 110 and the Packet data network GateWay (PGW) 113. The SGW 110 and the PGW 113 is connected via a S5 interface. The SGW 110 is connected to the MME 105 via the S11 interface. The SGW 110 is connected to the E-UTRAN 103 via the S1-U interface. The MME 105 is connected to a Serving GPRS Support Node (SGSN) 115. GPRS is short for General Packet Radio Service. The SGSN 115 is connected to the SGW 110 via the S4 interface and to the MME 105 via the S3 interface. The SGSN 115 offers support for GERAN 118 and UTRAN 120 to the core network. The UTRAN 120 is connected to the SGW 110 via the S12 interface. The PGW 113 may interact with a Policy and Charging Rules Function (PCRF) 120 via a Gx interface. The PGW 113 is connected to an operator's IP services 123, e.g. IP Multimedia Subsystem (IMS) and Packet Switch Streaming (PSS), via the SGi interface, and the PCRF 120 is connected to the operator's IP services 123 via the Rx interface. GERAN is short for GSM EDGE Radio Access Network, where GSM is short for Global System for Mobile Communications and EDGE is short for Enhanced Data rates for GSM Evolution. UTRAN is short for Universal Terrestrial Radio Access Network.

The term radio access network node or RAN node will in the following be used when referring to a base station, a Radio Network Controller (RNC) or a Base Station Controller (BSC) (not shown in FIG. 1). The term core network node will be used in the following when referring to the MME 105, SGSN 115, HSS 108, SGW 110, PGW 113 or PCRF 120.

The Third Generation Partnership Project (3GPP) network may be organized using network sharing. A shared network allows different core network operators to connect to a shared radio access network. The operators share both the radio network elements, and may also share the radio resources. At network sharing, the 3GPP standard provides two reference architectures; Gateway Core Network (GWCN) and Multi-Operator Core Network (MOCN). In GWCN, the MME is shared between the core network operators in addition to the radio access network. In MOCN, only the radio access network is shared between the core network operators. The behavior of the user equipment is the same in GWCN as in MOCN.

FIG. 2 illustrates an embodiment of a GWCN configuration for network sharing. FIG. 2 shows an example with three core network nodes operated by three different operators, operator A, B and C. The three core network nodes exemplified in FIG. 2 is: Core Network Node operator A 201a, Core Network Node operator B 201b and Core Network Node operator C 201c. The three Mobile Switching Center (MSC)/SGSN 203a, 203b, 203c are shared amongst the core network operators A, B and C, and is therefore referred to as a shared MSC/SGSN. The MSC is a network node responsible for coordinating communications channels and processes in the network. The MSC processes requests for service connections from the user equipments, and routes calls, SMS etc. between the base station and the Public Switched Telephone Network (PSTN). The SGSN performs the same functions as the MSC for voice traffic. Note that three CN operators are illustrated as an example, and that any suitable number of CN operators may be used, such as for example eight. The dotted lines illustrate the connection between the core network node operator A 201a and each of the respective shared MSC/SGSN 203a, 203b, 203c. The thin continuous lines illustrate the connection between the core network node operator B 201b and each of the respective shared MSC/SGSN 203a, 203b, 203c. The thick continuous lines illustrate the connection between the core network node operator C 201c and each of the respective shared MSC/SGSN 203a, 203b, 203c. The Iu interface 204 enables interconnection of Radio Network Controllers (RNC) 205a, 205b, 205b with the shared MSC/SGSN 203a, 203b, 203c. The Iu interface 204 is for circuit switched traffic between the RNC 205a, 205b, 205b and the MSC and for packet switched traffic between the RNC 205a, 205b, 205b and the SGSN. The RNC 205a, 205b, 205b is located in the radio access network operated by operator x.

FIG. 3 illustrates MOCN configuration for network sharing. FIG. 3 illustrates an example with three core network nodes 301 operated by three operators A, B and C. The exemplified core nodes 301 are core network node operator A 301A, core network node operator B 301B and core network node operator C 301C. The core network nodes 301 share the same RNC 305. The Iu interface 304 enables interconnection between the RNC 305 and the core nodes 301. The RNC 305 is located in the radio access network and operated by operator x.

For the EPS, only the Packet Switched (PS) domain of FIGS. 1-2 is relevant. FIGS. 1 and 2 both apply for E-UTRAN access, but with the MME replacing the SGSN, the base station replacing the RNC, and the 51 reference point replacing the Iu interface. The Iu interface is the interface between the core network and the radio access network.

The user equipment starts to interact with the 3GPP network by executing an attach procedure. When executing an attach procedure the user equipment sends an attach request message. The radio network may support user equipment mobility in connected mode by using a handover procedure. In connected mode a user equipment transmits and receives data. In idle mode, after the user equipment is switched on, the user equipment selects a PLMN and the user equipment searches for a suitable cell of this PLMN to camp on. The user equipment stays in idle mode until it transmits a request to establish a connection.

A PLMN is a network with the objective of providing wireless communication and to interlink the wireless network with the fixed wired network. A PLMN is identified by a PLMN ID comprising a Mobile Country Code (MCC) and a Mobile Network Code (MNC). Each operator providing mobile services may have its own PLMN. PLMNs interconnect with other PLMNs and PSTNs for telephone communications or with internet service providers for data and internet access of which links are defined as interconnect links between providers.

The term handover refers to transfer of the user equipment connection from one radio channel to other. There are different types of handover, such as for example hard or soft. Soft handover occurs when the channel in the source cell is retained and used for a while in parallel with the channel in the target cell. Hard handover occurs when the radio links for the user equipment change and there are no radio links that are common before the procedure is initiated and after the procedure is completed.

At execution of a handover procedure the radio access network node that is currently serving the user equipment selects a suitable target cell and signals to the currently serving core network node that the user equipment should be moved using a handover procedure. The handover target selected by the radio access network node may comprise a change of 3GPP access, e.g. a change between any two of a UTRAN, a GERAN and an E-UTRAN.

When current 3GPP radio access is E-UTRAN, the base station may have access to a Handover Restriction List (HRL). The handover restriction list provides the base station with information indicating allowed and restricted target cells and the base station shall use the information if it is provided.

In the E-UTRAN access the handover restriction list may be used to provide the base station with information indicating currently serving PLMN, allowed target PLMNs, restricted target locations, and restricted target accesses, also non-3GPP accesses. Allowed target PLMNs are the PLMN IDs listed as part of equivalent PLMNs together with the currently serving PLMN.

When the handover target location is in a shared network the source radio access network node will according to the 3GPP standard, select a target PLMN equal to its currently serving PLMN as a first priority.

Consider a network scenario of:
a shared network X served by the two operators A and B, and
an adjacent network Y served by only operator A.

In this scenario the network Y is currently serving a roaming user equipment which Home PLMN (HPLMN) is operated by B. According to the 3GPP, roaming refers to the ability for a user equipment to function in a serving network different from the home network. The serving network could be a shared network operated by two or more network operator.

The user equipment is geographically moving in a direction towards the shared network X, which triggers the base station which is serving the user equipment, the source base station, to start executing the handover procedure.

Since the PLMN in which the user equipment is currently served, is served also at the intended target location in network X, the source base station will select the PLMN A as the target serving PLMN.

However, since also operator B is serving the target location, and the HPLMN of the user equipment is PLMN B, the PLMN selection made by the source base station forces the user equipment to remain served by PLMN A as a roaming user equipment at the target location which is in direct conflict with assumed operator roaming agreement.

The incorrect selection of serving PLMN by the source base station remains as long as the user equipment remains in connected state and until the user equipment performs a PLMN selection in idle mode.

The impact from the incorrect PLMN selection is
1. that the user equipment is denied services that are only provided to the user equipment while it is visiting the home network,
2. that the user equipment as a consequence of 1. is subject to constraints imposed by the roaming condition,
3. that the user equipment is subject to incorrect charging from the roaming situation.

The problem outlined above is not only present in E-UTRAN but also when the target access is UTRAN or GERAN.

In UTRAN and GERAN the radio node may be guided by information similar to but different from the handover restriction list.

### SUMMARY

An objective of embodiments herein is therefore to obviate at least one of the above disadvantages and to provide improved handover in a communications network.

According to a first aspect, the object is achieved by a method in a source core network node for handling handover of a user equipment from a source location to a target shared location. The target shared location is shared between core network operators. The source core network node receives, from a source radio access network node, a request for handover of the user equipment from the source location to the target shared location. The request comprises information indicating the first target PLMN served at the target shared location and intended to serve the user equipment at the target shared location. The source core network node obtains information indicating a candidate target PLMN associated with the user equipment. The candidate target PLMN is served at the target shared location. The source core network node determines, based on the received information indicating the first target PLMN and the obtained information indicating the candidate target PLMN, that the first target PLMN shall be replaced by a second target PLMN to serve the user equipment in the target shared location. The second target PLMN is served at the target shared location.

According to a second aspect, the object is achieved by a source core network node for handling handover of a user equipment from a source location to a target shared location. The target shared location is shared between core network operators. The source core network node comprises a receiving port adapted to receive, from a source radio access network node, a request for handover of the user equipment from the source location to the target shared location. The request comprises information indicating a first target PLMN served at the target shared location and intended to serve the user equipment at the target shared location. The source core network node comprises a processing unit adapted to obtain information indicating a candidate target PLMN associated with the user equipment. The candidate target PLMN is served at the target shared location. The processing unit is further adapted to determine, based on the received information indicating the first target PLMN and the obtained information indicating the candidate target PLMN, that the first target PLMN shall be replaced by a second target PLMN to serve the user equipment in the target shared location. The second target PLMN is served at the target shared location.

The embodiments herein perform PLMN selection in the source core network node when receiving a request for handover from the source radio access network node. This is done by substituting the PLMN received from source radio access network node with other PLMN selected by an internal algorithm in the source core network node when performing handover into a MOCN network or a GWCN network.

Embodiments herein afford many advantages, of which a non-exhaustive list of examples follows:

An advantage of the embodiments herein is that it provides a competing solution based on logic in the source radio access network node.

A non-working solution would be to provide the source radio access network node with information that the currently serving PLMN is not an allowed target PLMN. That is only true for a handover in the direction to the shared location but not for a handover where the user equipment should remain handled by current PLMN.

Instead, the configuration that the source radio access network node may need access to is restrictions in the PLMN selection at all possible target locations such that the source radio access network node is able to understand that current served PLMN is not allowed at the target location. This may be achieved by configuration but with substantial drawbacks compared to the core network based embodiment. One drawback is that it requires a change in all impacted radio access network nodes. Another drawback is that each radio access network node must be provided with its individual configuration (matching the radio access network node's possible handover targets), or it must be provided with configuration matching the entire network and the network's adjacent or overlaid other networks to which handover is supported.

Another advantage of the embodiments herein is that they only impact the core network. The embodiments herein work with legacy radio access network node logic. It will work also in any type of radio access network, from any type of vendor.

The embodiments herein are not limited to the features and advantages mentioned above. A person skilled in the art will recognize additional features and advantages upon reading the following detailed description.

### BRIEF DESCRIPTION OF THE DRAWINGS

The embodiments herein will now be further described in more detail in the following detailed description by reference to the appended drawings illustrating the embodiments and in which:

FIG. 1 is a schematic block diagram illustrating embodiments of a non-roaming architecture for EPS.

FIG. 2 is a schematic block diagram illustrating embodiments of a GWCN configuration for network sharing.

FIG. 3 is a schematic block diagram illustrating embodiments of a MOCN configuration for network sharing.

FIG. 4 is a schematic block diagram illustrating embodiments of a communications network.

FIG. 5a is a signaling diagram illustrating embodiments of a method.

FIG. 5b is a schematic block diagram illustrating embodiments of MOCN and GWCN.

FIG. 6 is a flow chart illustrating embodiments of a method in a source core network node.

FIG. 7 is a schematic block diagram illustrating embodiments of a source core network node.

The drawings are not necessarily to scale and the dimensions of certain features may have been exaggerated for the sake of clarity. Emphasis is instead placed upon illustrating the principle of the embodiments herein.

### DETAILED DESCRIPTION

The embodiments herein perform PLMN selection in the source core network node when receiving a request for handover from a source radio access network node. This is done by substituting the first PLMN received from source radio access network node with another second PLMN selected by an internal algorithm in the source core network node when performing handover (into a target shared location which is a MOCN network or a GWCN network.

FIG. 4 depicts a communications network 400 in which embodiments herein may be implemented. The communications network 400 comprises a source location 400s and a target location 400t. The source location 400s refers to the location being registered as the home location of a user equipment 401. The user equipment 401 may roam between for example the source location 400s and the target location 400t. The source location 400s may serve a number of PLMNs and the target location 400t may serve a number of PLMNs.

The communications network 400 may in some embodiments apply to one or more radio access technologies such as for example LTE, LTE Advanced, Wideband Code Division Multiple Access (WCDMA), GSM, or any other 3GPP radio access technology.

The target location 400t may be a shared network, as described above.

The user equipment 401 is served by a source radio access network node 405s in the source location 400s. The source radio access network node 405s may be a RNC, a BSC or a base station such as a NodeB, an eNodeB, or any other network unit capable to communicate over a radio carrier with the user equipment 401. The source location 400s further comprises a source core network node 410s connected to the source radio access network node 405s. The source core network node 410s may be a source MME, source SGSN, source MSC, source HSS, source S-GW, source P-GW or source PCRF. The target location 400t comprises a target core network node 410t. The target core network node 410t may be a target MME, target SGSN, target MSC, target HSS, target S-GW, target P-GW or target PCRF. The target location 400t further comprises a target radio access network node 405t serving the user equipment 401 when it has been handed over to the target location 400t.

The user equipment 401 may be any suitable communication device or computational device with communication capabilities capable to communicate with a base station over a radio channel, for instance but not limited to user equipment, mobile phone, smart phone, Personal Digital Assistant (PDA), tablet computer, laptop, MP3 player or portable DVD player (or similar media content devices), Machine to Machine (M2M) device, digital camera, or even stationary devices such as a PC. A PC may also be connected via a mobile station as the end station of the broadcast/multicast media. The user equipment 401 may also be an embedded communication device in e.g. electronic photo frames, cardiac surveillance equipment, intrusion or other surveillance equipment, weather data monitoring systems, vehicle, car or transport communication equipment, etc. The user equipment 401 is referred to as UE in some of the figures.

The method for handover of the user equipment 401 from a source location 400s to a target shared location 400t, according to some embodiments will now be described with reference to the signaling diagram depicted in FIG. 5a. The target shared location 400t may be a MOCN or a GWCN, which will be described in more detail below with reference to FIG. 5b.

The method comprises the following steps, which steps may as well be carried out in another suitable order than described below.

### Step 501

The source radio access network node 405s transmits a request for handover of the user equipment 401 from the source location 400s to target shared location 400t. Transmittal of the request for handover may be triggered when the source radio access network node 405s detects that the user equipment 401 is loosing coverage in the source location 400s, and a suitable target location 400t may be found. The request for handover comprises information indicating a first target PLMN served at the target shared location 400t. The first target PLMN is intended to serve the user equipment 401 at the target shared location 400t. The first target PLMN is determined by the source radio access network node 405s at a previous time.

### Step 502

The source core network node 410s obtains information indicating a candidate target PLMN. This information may be added to information indicating cooperating core network nodes. The information may be achieved by for example, extending a Domain Name Server (DNS) based configuration of cooperating target locations such that it comprises served target PLMNs at each target location. DNS is a technology for managing the names of web sites and other Internet domains. DNS technology makes it possible to type names into a Web browser and enables the computer to automatically find that address on the Internet. The above means that the source core network node 410s knows which target candidate PLMN that is served at the target location 400t.

The candidate target PLMN may be a source PLMN, a home PLMN of the user equipment 401, a PLMN based on local configuration in the source core network node 410s, or a PLMN that fulfills a criterion associated with the user equipment 401. The PLMN that fulfills the criterion may be referred to as a preferred PLMN for the user equipment 401. The criterion may be associated with admission control of the user equipment 401 at the target shared location 400s. The information indicating the first target PLMN may comprise the first target PLMN ID and the information indicating the candidate target PLMN may comprise the candidate target PLMN ID. This step 502 may be performed before or after step 501.

In more detail, at a request for handover the source core network node 410s may compare user equipment's 401 source location 400s, HPLMN (a single value extracted from the user equipment's 401 International Mobile Subscriber Identity (IMSI)), and a PLMN based on local configuration in the source core network node 410s, with the PLMNs served at the target location 400t. IMSI is a unique identification associated with the user equipment 401, and is predefined in the user equipment 401.

### Step 503

The source core network node 410s determines that the first target PLMN should be replaced by a second target PLMN intended to serve the user equipment 401 at the target shared location 400s. This may be based on the information in the received request for handover and/or based on the information indicating the candidate target PLMN. If the HPLMN of the user equipment 401, or a PLMN based on local configuration in the source core network node 405s, is served at the target location 400t, then this is selected as the second target PLMN.

Otherwise, if the currently serving PLMN at the source core network node 410s is served also at the target location 400t, then this is selected as the second target PLMN.

Else, the source core network node 410s selects a second target PLMN that may serve the users equipment 401.

### Step 504

When the source core network node 410s has determined that the first target PLMN should be replaced by the second target PLMN to serve the user equipment 401 at the target shared location 400s, the source core network node 410s then substitutes or replaces, in the request for handover, the first target PLMN selected by source radio access network node 405s with the second target PLMN selected by the source core network node 410s itself.

### Step 505

The handover procedure execution then continues, which means that the source core network node 410s as part of the handover preparation phase selects a target core network node 410t. The target core network node 410t may be selected based on the second target PLMN. The target core network node 410t may be selected from a plurality of selectable target core network nodes.

The selection of the target core network node 410t will be described with reference to FIG. 5b illustrating the differences between MOCN and GWCN. FIG. 5b illustrates the target core network node 410t in a MOCN on the left side of the line and in a GWCN on the right side of the line. In FIG. 5b, the MOCN is exemplified with two target core network nodes 410t, a and b. Note that the number two (2) is only used as an example. The target core network node 410t a is associated with PLMN a and operator a. The target core network node 410t b is associated with PLMN b and operator b. If for example, the second target PLMN is the same as PLMN b, the selected target core network node 410t will be target core network node 410t b. Since each target core network node in MOCN is associated with a respective target operator, the selection of the target core network node does not involve any selection of target operator. In FIG. 5b, the GWCN comprises one target core network node 410t. However, the target core network node 410t is shared by operator a serving PLMN a and operator b serving PLMN b. The source core network node 410t will select the target core network node 410t. If the second target PLMN is the same as PLMN b, the target core network node 410t will get information indicating the second target PLMN from the source core network node 410s. Based on the indication to the second target PLMN, the target core network node 410t will determine to which operator it shall direct its signaling, e.g. operator b.

Note that FIG. 5b is exemplified with two sharing operators. FIG. 5b does not illustrate pooled networks. In MOCN, one or more operators may have a pooled network. In GWCN, the network may be pooled or not (it is the same network for all sharing operators).

Returning to FIG. 5a.

### Step 506

The source core network node 410s sends a request message, e.g. such as a General Packet Radio Service Tunneling Protocol (GTP) request message, to the target core network node 410t. An example of a GTP request message is the GTP Forward Relocation Request message. GTP refers to communications protocols used to carry GPRS within GSM, UMTS and LTE networks. The request message provides the target core network node 410t with the necessary information in order to handle the handover of the user equipment 401. The information may indicate the user equipment 401, e.g. the IMSI, the second target PLMN ID, the cell to which the user equipment 401 shall be moved etc.

### Step 507

The target core network node 410t allocates resources for the user equipment 401 and handles the user equipment 401 when it is handed over to the target shared location 400t.

Now, the method described above will be elaborated seen from the perspective of the source core network node 410s. FIG. 6 is a flowchart describing the present method in the source core network node for handling handover of a user equipment 401 from a source location 400s to a target shared location 400t. The source core network node 410s may be at least one of a MME and/or a SGSN and/or a MSC. The source radio access network node 405s may be at least one of a RNC and/or a BSC and/or a base station. The target shared location 400t may be a MOCN or a GWCN shared by multiple operators. Each operator of the multiple operators may be associated with a respective candidate target PLMN. The method comprises the following steps to be performed by the source core network node 410s, which steps may be performed in any suitable order:

### Step 601

This step 601 corresponds to step 501 in FIG. 5. The source core network node 410s receives, from the source radio access network node 405s, a request for handover of the user equipment 401 from the source location 400s to the target shared location 400t. The request comprises information indicating the first target PLMN (e.g. PLMN a or PLMN b indicated in FIG. 5b) served at the target shared location 400t and intended to serve the user equipment 401 at the target shared location 400t. The first target PLMN is determined by the source radio access network node 405s.

### Step 602

This step 602 corresponds to step 502 in FIG. 5. In some embodiments, the source core network node 410s obtains information indicating the candidate target PLMN associated with the user equipment 401. The candidate target PLMN is served at the target shared location 400t. The information indicating the first target PLMN may comprise a first target PLMN ID. The information indicating the candidate target PLMN may comprise a candidate target PLMN ID.

The information indicating the candidate target PLMN may e.g. be preconfigured in the source core network node 410s or it may be obtained by local configuration in the source core network node 410s. There may be one or more candidate target PLMNs.

The candidate target PLMN may e.g. be a source PLMN, a home PLMN of the user equipment 401, a PLMN based on local configuration in the source core network node 410s or a candidate target PLMN that fulfills a criterion associated with the user equipment 401. The target PLMN that fulfills the criterion may be referred to as a preferred target PLMN for the user equipment 401.

### Step 603

Based on the received information indicating the first target PLMN and information indicating the candidate target PLMN, the source core network node 410s determines that the first target PLMN should be replaced by a second target PLMN to serve the user equipment 401 in the target shared location 400t. The second target PLMN is served at the target shared location 400t. The candidate target PLMN is associated with the user equipment 401 and served at the target shared location 400t.

In some embodiments, when the information indicating the candidate target PLMN comprises information indicating the home PLMN of the user equipment 401, the source core network node 410 selects the home PLMN as the second target PLMN when the home PLMN is served at the target shared location 400t.

In some embodiments, when the information indicating the candidate target PLMN comprises information indicating the PLMN based on local configuration in the source core network node 410s, the source core network node 410 selects the PLMN based on local configuration as the second target PLMN when the PLMN based on local configuration is served at the target shared location 400t.

As mentioned earlier, the home PLMN is the PLMN where the subscription associated with the IMSI belongs to. The home PLMN may e.g. be identified by the first digits in the IMSI. In other words, the home PLMN is a PLMN where the MCC and the MNC of the PLMN ID are the same as the MCC and MNC of the IMSI.

In some embodiments, the user equipment 401 is served by a source PLMN in the source location 400s and the information indicating the candidate target PLMN comprises information indicating the source PLMN. In such embodiments, the source core network node 410s selects the source PLMN as the second target PLMN when the source PLMN is served at the target shared location 400t. The source PLMN is the location which the handover goes from.

In some embodiments, when the candidate target PLMN fulfills a criterion associated with the user equipment 401, the source core network node 410s selects the candidate target PLMN fulfilling the criterion as the second target PLMN when the candidate target PLMNs fulfilling the criterion is served at the target shared location 400t. The criterion may be associated with admission control of the user equipment 401 at the target shared location 400t.

### Step 604

This step 604 corresponds to step 504 in FIG. 5. The source core network node 410s replaces the information indicating the first target PLMN in the request for handover with the determined second target PLMN.

### Step 605

This step 605 corresponds to step 505 in FIG. 5. In some embodiments, the source core network node 410s selects a target core network node 410t. The target core network node 410t may be selected based on the information indicating the second target PLMN. The target core network node 410t may be selected from a plurality of selectable target core network nodes. In some embodiments, i.e. a GWCN network, the plurality of selectable target core network nodes each serves a plurality of target operators. For GWCN all target core network nodes serves all target operators. There may be several different target PLMN's which leads to the same target core network operator.

### Step 606

This step 606 corresponds to step 506 in FIG. 5. In some embodiments, the source core network node 410s transmits a request message comprising information to the selected target core network node 410t. This request information enables the selected target core network node 410t to allocate resources for the user equipment 401 and handling the user equipment 401 when it is handed over to the target core network 410t. The request information may indicate the user equipment 401, e.g. the IMSI, the second target PLMN

ID, information indicating the cell to which the user equipment 401 shall be moved etc. The request message may be e.g. a GTP Forward Relocation Request message, as mentioned earlier.

To perform the method steps shown in FIG. 6 for handling handover of a user equipment 401 from the source location 400s to the target shared location 400t, the source core network node 410s comprises an arrangement as shown in FIG. 7. The target shared location 400t is shared between core network operators. FIG. 7 is a schematic block diagram illustrating embodiments of a source core network node 410s implementing the embodiments herein. The source core network node 410s may be at least one of a MME and a SGSN and a MSC. The source radio access network node 405s may be at least one of a RNC, a BSC and a base station. The target shared location 400t may be a MOCN or a GWCN shared by multiple operators, where each operator of the multiple operators is associated with a respective target candidate PLMN. Even though FIG. 7 illustrates the source core network node 410s, the figure may also represent the target core network node 410t.

The source core network node 410s comprises a receiving port 701 adapted to receive data, signals and messages from other nodes in the communications network 400. The receiving port 701 is adapted to receive, from the source radio access network node 405s, the request for handover of the user equipment 401 from the source location 400s to the target shared location 400t. The request comprises information indicating the first target PLMN served at the target shared location 400t and indented to serve the user equipment 401 at the target shared location 400t. The first target PLMN is determined by the source radio access network node 405s.

The source core network node 410s further comprises a transmitting port 705 adapted to transmit data, signals and message to other nodes in the network 400. The transmitting port 705 may be adapted to transmit a request message to the selected target core network node 410t, enabling the selected target core network node 410t to allocate resources for the user equipment 401 and handling the user equipment 401 when it is handed over to the target core network 410t.

The source core network node 410s further comprises a processing unit 710 adapted to obtain information indicating the candidate target PLMN associated with the user equipment. The candidate target PLMN is served at the target shared location 400t.

The processing unit 710 is further adapted to determine to replace the first target PLMN with the second target PLMN to serve the user equipment 401 in the target shared location 400t. The determination is based on the information indicating the first target PLMN and the information indicating the candidate target PLMN. The second target PLMN is served at the target shared location 400t.

In some embodiments, the information indicating the candidate target PLMN comprises information indicating a home PLMN of the user equipment 401. The processing unit 710 may be further adapted to select the home PLMN as the second target PLMN when the home PLMN is served at the target shared location 400t.

In some embodiments, the information indicating the candidate target PLMN comprises information indicating a PLMN based on local configuration in the source core network node 410s. The processing unit 710 may be further adapted to select the PLMN based on local configuration as the second target PLMN when the PLMN based on local configuration is served at the target shared location 500t.

In some embodiments, the user equipment 401 is adapted to be served by a source

PLMN in the source location 400s. The information indicating the candidate target PLMN may comprise information indicating the source PLMN. The processing unit 710 may be further adapted to select the source PLMN as the second target PLMN when the source PLMN is served at the target shared location 400t.

In some embodiments, the candidate target PLMN fulfills a criterion associated with the user equipment 401. The processing unit 710 may be adapted to select the candidate target PLMN fulfilling the criterion as the second target PLMN when the candidate target PLMNs fulfilling the criterion is served at the target shared location 400t.

The processing unit 710 is further adapted to replace the information indicating the first target PLMN in the request for handover with the second target PLMN, and to select a target core network node 410t. The processing unit 701 may be adapted to select the target core network node 410t based on the second target PLMN. The processing unit 701 may be adapted to select the target core network node 410t from a plurality of selectable target core network nodes. In some embodiments, i.e. for GWCN, the plurality of selectable target core network nodes each serves a plurality of target operators. For GWCN all target core network nodes serves all target operators. There may be several different target PLMN's which leads to the same target core network operator.

The embodiments may be implemented through one or more processors in the source core network node 410s, such as the processing unit 710 illustrated in FIG. 7, together with computer program code for performing the functions of the embodiments herein. The processor may be for example a Digital Signal Processor (DSP), Application Specific Integrated Circuit (ASIC) processor, Field-programmable gate array (FPGA) processor or micro processor. The program code mentioned above may also be provided as a computer program product, for instance in the form of a data carrier carrying computer program code for performing the embodiments herein when being loaded into the source core network node 410s. One such carrier may be in the form of a CD ROM disc. It is however feasible with other data carriers such as a memory stick. The computer program code may furthermore be provided as pure program code on a server and downloaded to the source core network node 410s.

Some embodiments described above may be summarized in the following manner:

One embodiment is directed to a method in a source core network node for handling handover of a user equipment from a source location to a target shared location, which target shared location is shared between core network operators—The method comprises the steps of: receiving, from a source radio access network node, a request for handover of the user equipment from the source location to the target shared location, which request comprises information indicating a first target Public Land Mobile Network, PLMN served at the target shared location and intended to serve the user equipment at the target shared location; and obtaining information indicating a candidate target PLMN associated with the user equipment, which candidate target PLMN is served at the target shared location; and determining, based on the received information indicating the first target PLMN and the obtained information indicating the candidate target PLMN, that the first target PLMN shall be replaced by a second target PLMN to serve the user equipment in the target shared location, which second target PLMN is served at the target shared location.

The method may comprise the steps of replacing the information indicating the first target PLMN in the request for handover with information indicating the second target PLMN.

The method may comprise the steps of: selecting a target core network node; and transmitting a request comprising the information indicating the second target PLMN to the selected target core network node, enabling the selected target core network node to allocate resources for the user equipment and handling the user equipment when it is handed over to the target core network.

The method may comprise the steps of selecting the target core network node from a plurality of selectable target core network nodes, which selecting is based on the information indicating the second target PLMN.

The plurality of selectable target core network nodes may each serve a plurality of target operators.

The information indicating the first target PLMN may comprise a first target PLMN ID, and the information indicating the candidate target PLMN may comprise a candidate target PLMN ID.

The information indicating the candidate target PLMN may comprise information indicating a home PLMN of the user equipment, and the determining may be done by selecting the home PLMN of the user equipment as the second target PLMN when the home PLMN of the user equipment is served at the target shared location.

The information indicating the candidate target PLMN may comprise information indicating a PLMN based on local configuration in the source core network node, and the determining may be done by selecting the PLMN based on local configuration as the second target PLMN when the PLMN based on local configuration is served at the target shared location.

The user equipment may be served by the source PLMN in the source location, and the information indicating the candidate target PLMN may comprise information indicating the source PLMN, and the determining may be done by selecting the source PLMN as the second target PLMN when the source PLMN is served at the target shared location.

The candidate target PLMN may fulfill a criterion associated with the user equipment, and the determining may be done by selecting the candidate target PLMN fulfilling the criterion as the second target PLMN when the candidate target PLMNs fulfilling the criterion is served at the target shared location.

The criterion may be associated with admission control of the user equipment at the target shared location.

The source core network node may be at least one of; a Mobility Management Entity (MME) and/or a Serving General packet radio service Support Node (SGSN) and/or a Mobile Switching Center (MSC), and the source radio access network node may be at least one of; a Radio Network Controller (RNC) and/or a Base Station Controller (BSC) and/or a base station.

The target shared location may be a Multi Operator Core Network (MOCN) or a GateWay Core Network (GWCN), shared by multiple operators, wherein each operator of the multiple operators is associated with a respective target candidate PLMN.

Some other embodiments described above may be summarized in the following manner:

One other embodiment is directed to a source core network node for handling handover of a user equipment from a source location to a target shared location, which target shared location is shared between core network operators. The source core network node comprises: a receiving port adapted to receive, from a source radio access network node, a request for handover of the user equipment from the source location to the target shared location, which request comprises information indicating a first target Public Land Mobile Network, PLMN, served at the target shared location and intended to serve the user equipment at the target shared location; and a processing unit adapted to obtain information indicating a candidate target PLMN associated with the user equipment, which candidate target PLMN is served at the target shared location, and adapted to determine, based on the received information indicating the first target PLMN and the obtained information indicating the candidate target PLMN, that the first target PLMN shall be replaced with a second target PLMN to serve the user equipment in the target shared location, which second target PLMN is served at the target shared location.

The processing unit may be further adapted to replace the information indicating the first target PLMN in the request for handover with information indicating the second target PLMN.

The processing unit may be further adapted to select a target core network node; and the source core network node may further comprises a transmitting port adapted to transmit a request comprising the information indicating the second target PLMN to the selected target core network node, enabling the selected target core network node to allocate resources for the user equipment and handling the user equipment when it is handed over to the target core network.

The processing unit may be adapted to select, from a plurality of selectable target core network nodes, the target core network node based on the information indicating the second target PLMN.

Each target core network node of the plurality of selectable target core network nodes may be adapted to serve a plurality of target operators.

The information indicating the first target PLMN may comprise a first target PLMN ID and the information indicating the candidate target PLMN may comprise a candidate target PLMN ID.

The information indicating the candidate target PLMN may comprise information indicating a home PLMN of the user equipment, and the processing unit may be further adapted to select the home PLMN of the user equipment as the second target PLMN when the home PLMN of the user equipment is served at the target shared location.

The information indicating the candidate target PLMN may comprise information indicating a PLMN based on local configuration in the source core network node, and the processing unit may be further adapted to select the PLMN based on local configuration as the second target PLMN when the PLMN based on local configuration is served at the target shared location.

The user equipment may be adapted to be served by a source PLMN in the source location, and the information indicating the candidate target PLMN may comprise information indicating the source PLMN, and the processing unit may be further adapted to select the source PLMN as the second target PLMN when the source PLMN is served at the target shared location.

The candidate target PLMN may fulfill a criterion associated with the user equipment, and the processing unit may be adapted to select the second target PLMN as the candidate target PLMN fulfilling the criterion when the candidate target PLMNs fulfilling the criterion is served at the target shared location.

The criterion may be associated with admission control of the user equipment at the target shared location.

The source core network node may be at least one of; a Mobility Management Entity (MME) and/or a Serving General packet radio service Support Node (SGSN) and/or a Mobile Switching Center (MSC) and the source radio access network node may be at least one of; a Radio Network Controller (RNC) and/or a Base Station Controller (BSC) and/or a base station.

The target shared location may be a Multi Operator Core Network (MOCN) or a GateWay Core Network (GWCN), shared by multiple operators, wherein each operator of the multiple operators is associated with a respective target candidate PLMN.

The embodiments herein are not limited to the above described preferred embodiments. Various alternatives, modifications and equivalents may be used.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

It should also be emphasized that the steps of the methods defined in the appended claims may, without departing from the embodiments herein, be performed in another order than the order in which they appear.

1. A method in a source core network node for handling handover of a user equipment from a source location to a target shared location, which target shared location is shared between core network operators, the method comprising:
receiving, from a source radio access network node, a request for handover of the user equipment from the source location to the target shared location, which request comprises information indicating a first target Public Land Mobile Network, PLMN served at the target shared location and intended to serve the user equipment at the target shared location;
obtaining information indicating a candidate target PLMN associated with the user equipment, which candidate target PLMN is served at the target shared location; and
determining, based on the received information indicating the first target PLMN and the obtained information indicating the candidate target PLMN, that the first target PLMN shall be replaced by a second target PLMN to serve the user equipment in the target shared location, which second target PLMN is served at the target shared location.

2. The method according to claim 1, further comprising:
replacing the information indicating the first target PLMN in the request for handover with information indicating the second target PLMN.

3. The method according to claim 1, further comprising:
selecting a target core network node; and
transmitting a request comprising the information indicating the second target PLMN to the selected target core network node, enabling the selected target core network node to allocate resources for the user equipment and handling the user equipment when it is handed over to the target core network.

4. The method according to claim 3, wherein the target core network node is selected from a plurality of selectable target core network nodes based on the information indicating the second target PLMN.

5. The method according to claim 4, wherein the plurality of selectable target core network nodes each serves a plurality of target operators.

6. The method according to claim 1, wherein the information indicating the first target PLMN comprises a first target PLMN ID, and wherein the information indicating the candidate target PLMN comprises a candidate target PLMN ID.

7. The method according to claim 1, wherein the information indicating the candidate target PLMN comprises information indicating a home PLMN of the user equipment, and wherein the determining is done by:
selecting the home PLMN of the user equipment as the second target PLMN when the home PLMN of the user equipment is served at the target shared location.

8. The method according to claim 1, wherein the information indicating the candidate target PLMN comprises information indicating a PLMN based on local configuration in the source core network node, and wherein the determining is done by:
selecting the PLMN based on local configuration as the second target PLMN when the PLMN based on local configuration is served at the target shared location.

9. The method according to claim 1, wherein the user equipment is served by a source PLMN in the source location, wherein the information indicating the candidate target PLMN comprises information indicating the source PLMN, and wherein the determining is done by:
selecting the source PLMN as the second target PLMN when the source PLMN is served at the target shared location.

10. The method according to claim 1, wherein the candidate target PLMN fulfills a criterion associated with the user equipment, and wherein the determining is done by:
selecting the candidate target PLMN fulfilling the criterion as the second target PLMN when the candidate target PLMNs fulfilling the criterion is served at the target shared location.

11. The method according to claim 10, wherein the criterion is associated with admission control of the user equipment at the target shared location.

12. The method according to claim 1, wherein the source core network node is at least one of a Mobility Management Entity, MME and a Serving General packet radio service Support Node, SGSN and a Mobile Switching Center, MSC, and wherein the source radio access network node is at least one of a Radio Network Controller, RNC and a Base Station Controller, BSC and a base station.

13. The method according to claim 1, wherein the target shared location is a Multi Operator Core Network, MOCN, or a GateWay Core Network, GWCN, shared by multiple operators, wherein each operator of the multiple operators is associated with a respective target candidate PLMN.

14. A source core network node for handling handover of a user equipment from a source location to a target shared location, which target shared location is shared between core network operators, the source core network node comprising:
a receiving port adapted to receive, from a source radio access network node, a request for handover of the user equipment from the source location to the target shared location, which request comprises information indicating a first target Public Land Mobile Network, PLMN, served at the target shared location and intended to serve the user equipment at the target shared location; and
a processing unit adapted to:
obtain information indicating a candidate target PLMN associated with the user equipment, which candidate target PLMN is served at the target shared location, and
determine, based on the received information indicating the first target PLMN and the obtained information indicating the candidate target PLMN, that the first target PLMN shall be replaced with a second target PLMN to serve the user equipment in the target shared location, which second target PLMN is served at the target shared location.

15. The source core network node according to claim 14, wherein the processing unit is further adapted to:
replace the information indicating the first target PLMN in the request for handover with information indicating the second target PLMN.

16. The source core network node according to claim 14, wherein the processing unit is further adapted to select a target core network node;
and wherein the source core network node further comprises:
a transmitting port adapted to transmit a request comprising the information indicating the second target PLMN to the selected target core network node, enabling the selected target core network node to allocate resources for the user equipment and handling the user equipment when it is handed over to the target core network.

17. The source core network node according to claim 16, wherein the processing unit is adapted to select, from a plurality of selectable target core network nodes, the target core network node based on the information indicating the second target PLMN.

18. The source core network node according to claim 17, wherein each target core network node of the plurality of selectable target core network nodes is adapted to serve a plurality of target operators.

19. The source core network node according to claim 14, wherein the information indicating the first target PLMN comprises a first target PLMN ID and wherein the information indicating the candidate target PLMN comprises a candidate target PLMN ID.

20. The source core network node according to claim 14, wherein the information indicating the candidate target PLMN comprises information indicating a home PLMN of the user equipment, and wherein the processing unit is further adapted to:
select the home PLMN of the user equipment as the second target PLMN when the home PLMN of the user equipment is served at the target shared location.

21. The source core network node according to claim 14, wherein the information indicating the candidate target PLMN comprises information indicating a PLMN based on local configuration in the source core network node, and wherein the processing unit is further adapted to:
select the PLMN based on local configuration as the second target PLMN when the PLMN based on local configuration is served at the target shared location.

22. The source core network node according to claim 14, wherein the user equipment is adapted to be served by a source PLMN in the source location, wherein the information indicating the candidate target PLMN comprises information indicating the source PLMN, and
wherein the processing unit is further adapted to:
select the source PLMN as the second target PLMN when the source PLMN is served at the target shared location.

23. The source core network node according to claim 14, wherein the candidate target PLMN fulfills a criterion associated with the user equipment, and wherein the processing unit is adapted to:
select the second target PLMN as the candidate target PLMN fulfilling the criterion when the candidate target PLMNs fulfilling the criterion is served at the target shared location.

24. The source core network node according to claim 23, wherein the criterion is associated with admission control of the user equipment at the target shared location.

25. The source core network node according to claim 14, wherein the source core network node is at least one of a Mobility Management Entity, MME and a Serving General packet radio service Support Node, SGSN and a Mobile Switching Center, MSC, and wherein the source radio access network node is at least one of a Radio Network Controller, RNC, a Base Station Controller, BSC and a base station.

26. The source core network node according to claim 14, wherein the target shared location is a Multi Operator Core Network, MOCN, or a GateWay Core Network, GWCN, shared by multiple operators, wherein each operator of the multiple operators is associated with a respective target candidate PLMN.
